(19) United States
(12) Patent Application Publication
(10) Pub. No.: US 2025/0296165 A1
(43) Pub. Date: Sep. 25, 2025

(54) TIP SAW

(71) Applicant: TATSUNO SAWING DR. COMPANY, Nagano (JP)

(72) Inventor: Minoru KURIBAYASHI, Nagano (JP)

(21) Appl. No.: 19/227,420

(22) Filed: Jun. 3, 2025

Related U.S. Application Data
(62) Division of application No. 18/000,182, filed on Nov. 29, 2022.

(30) Foreign Application Priority Data
Dec. 22, 2020 (JP) 2020-212855

(51) Int. Cl. B23D 61/02; B23D 61/04; B27B 33/08

(52) U.S. Cl. CPC B23D 61/021; B23D 61/04; B27B 33/08

(57) ABSTRACT

A tip saw has a disc-shape and comprises cutting blade pieces and a base metal. The cutting blade pieces are disposed on blade edges of the tip saw, and each of the cutting blade pieces extends to a reverse rotation side of the each of the cutting blade pieces along an outer side of the tip saw. Two of the cutting blade pieces adjacent to each other partially overlap in a circumferential direction along the outer side of the tip saw. The each of the cutting blade pieces has a cutting edge portion on a rotation side of the each of the cutting blade pieces and a support portion on the reverse rotation side of the each of the cutting blade pieces.

### CROSS REFERENCE TO RELATED APPLICATION

This Application is a divisional application of U.S. patent application Ser. No. 18/000,182 filed on Nov. 29, 2022, which is a 371 of PCT/JP2021/006559 filed on Feb. 22, 2021, which claimed the priority of Japanese Patent Application 2020-212855 filed on Dec. 22, 2020, all of which are incorporated herein by reference.

### TECHNICAL FIELD

The present invention relates to a tip saw including cutting blade pieces such as tips on blade edge portions of a circular saw.

### BACKGROUND ART

FIG. 29 is a plan view illustrating a state where a pipe-shaped work material is cut by using a conventional tip saw. FIG. 30 is an enlarged view illustrating a range enclosed by an alternate long and short dash line vii in FIG. 29. As illustrated in FIGS. 29 and 30, cemented carbide has higher hardness and less deterioration in hardness under high temperatures than high-speed tool steel (high-speed steel, HSS), and cuts well when being used for blade edge portions of a cutting tool. Therefore, in recent years, a tip saw 1 configured by attaching cutting blade pieces 1a made of cemented carbide to blade edge portions has been frequently used. In the tip saw 1 of this type, the cutting blade pieces 1a are configured to be thicker than a base metal 1A.

FIG. 31 is a plan view illustrating a conventional tip saw described in Patent Document 1. This FIG. 31 is the same drawing as FIG. 1 of Patent Document 1. As illustrated in FIG. 31, in Patent Document 1, a tip saw 2 (circular saw) for pit sawing of wood is described. This tip saw 2 includes first cutting blade pieces 2a (insertion bodies) and second cutting blade pieces 2b (insertion bodies, facing elements or insertion bodies). These first cutting blade pieces 2a and second cutting blade pieces 2b are made of cemented carbide. The first cutting blade pieces 2a are attached to blade edge portions of the tip saw 2, and the second cutting blade pieces 2b are attached to edge portions of grooves 2s (slots) disposed between the blade edge portions. The grooves 2s extend radially inward, and are formed one on each of the left and the right of a rotation center O of the tip saw 2. Therefore, similarly to the grooves 2s, the second cutting blade pieces 2b are provided one on each of the left and the right of the rotation center O of the tip saw 2.

FIG. 32 is a plan view illustrating a conventional tip saw described in Patent Document 2. This FIG. 32 is the same drawing as FIG. 5 of Patent Document 2. As illustrated in FIG. 32, in Patent Document 2, a tip saw 3 (circular saw) preferable for cutting wood and wood panels is described. This tip saw 3 includes first cutting blade pieces 3a (tip inserts), second cutting blade pieces 3b (second wiper tips), and third cutting blade pieces 3c (first wiper tips). These first cutting blade pieces 3a, second cutting blade pieces 3b, and third cutting blade pieces 3c are made of cemented carbide. The first cutting blade pieces 3a are attached to blade edge portions. Three second cutting blade pieces 3b are provided on the tip saw 3, and are attached to edge portions of grooves 3s (expansion slits) between the blade edge portions. The grooves 3s extend radially inward, and are six in number formed at predetermined angular intervals around a rotation center O. The second cutting blade pieces 3b are provided on every other groove 3s around the rotation center O. Three third cutting blade pieces 3c are provided on the tip saw 3, and are attached to edge portions of slots 3h (openings) of a base metal 3A (base disc).

### PRIOR ART

### Patent Documents

Patent Document 1: Japanese Post-Grant Patent Publication No. S47-11320
Patent Document 2: Japanese Patent Publication No. 4754260

### SUMMARY OF INVENTION

### Technical Problem

Referring to FIGS. 29 and 30 again, a hollow work material P (having a cavity inside) with pipe shape or column shape (rectangular cylindrical shape), etc., is cut by using the conventional tip saw 1. Since the cutting blade pieces 1a are configured to be thicker than the base metal 1A, the cutting edge of the cutting blade piece 1a cuts the work material P to form a cut groove Pc. Although a width of the cut groove Pc is held equal to a thickness of the cutting blade piece 1a when the cutting blade piece 1a is inserted into the cut groove Pc, when the cutting blade piece 1a is not inserted into the cut groove Pc, the width of the cut groove Pc is held equal to a thickness of the base metal 1A, that is, held narrower than the thickness of the cutting blade piece 1a. Therefore, when cutting the hollow work material P, the width of the cut groove Pc of the work material P fluctuates to increase and decrease, and there is a problem that a cut surface of the work material P becomes rough.

To solve this problem, when the number of cutting blade pieces 1a of the tip saw 1 is increased, the interval between two adjacent cutting blade pieces 1a and 1a narrows, and the chip discharge performance of the tip saw 1 thus deteriorates. When the numbers of second cutting blade pieces 2b and 3b are increased by improving the tip saws 2 and 3 described in Patent Documents 1 and 2 illustrated in FIGS. 31 and 32, the numbers of grooves 2s and 3s formed in the base metals 2A and 3A are increased, so that the strengths of the base metals 2A and 3A decrease, and there is a risk that the tip saws 2 and 3 cannot cut wood. Therefore, it is considered that this improvement is not conceived in Patent Documents 1 and 2.

The present invention solves the problem described above, and an object thereof is to provide a tip saw with which a clean cut surface can be obtained when cutting a hollow work material.

### Solution to Problem

In order to solve the problem described above, a tip saw according to the present invention is a disc-shaped tip saw including cutting blade pieces on blade edges of the tip saw, wherein support pieces are disposed between adjoining two of the cutting blade pieces, the cutting blade pieces and the support pieces are configured to be thicker than a thickness of a base metal of the tip saw, and the support pieces have a thickness equal to or nearly equal to a thickness of the cutting blade pieces.

A tip saw according to this invention is a disc-shaped tip saw including cutting blade pieces on blade edges of the tip saw, wherein support pieces are disposed between adjoining two of the cutting blade pieces, the cutting blade pieces and the support pieces are configured to be thicker than a thickness of a base metal of the tip saw, and the support pieces have a thickness equal to or nearly equal to a thickness of the cutting blade pieces. Accordingly, each of the support pieces has a thickness equal to or nearly equal to a thickness of the cutting blade piece, and is disposed between adjoining two of the cutting blade pieces, so that without an increase in the number of the cutting blade pieces of the tip saw, a width of a cut groove formed in a work material by the cutting blade pieces can be held equal to or nearly equal to the thickness of the cutting blade pieces by the support pieces.

In the present invention, it is preferable that the support pieces are disposed so as to include at least a center position between adjoining two of the cutting blade pieces or are disposed so as to include a position near the center position. According to this invention, due to the fact that the support pieces are disposed so as to include at least a center position between adjoining two of the cutting blade pieces or are disposed so as to include a position near the center position, variation in distances between adjoining the cutting blade pieces and the support pieces can be decreased as compared with a case where the support pieces are biased toward one of the two adjacent cutting blade pieces and a portion of the support pieces are not disposed at the center position between the two adjacent cutting blade pieces or a position near the center position.

Here, disposing the support pieces so as to include at least a center position between adjoining two of the cutting blade pieces or so as to include a position near the center position includes the following cases: A case where the support pieces are disposed at a center position between adjoining two of the cutting blade pieces. A case where the support pieces are entirely biased toward one of adjoining two of the cutting blade pieces, and a portion of the support pieces are disposed at a center position between adjoining two of the cutting blade pieces or disposed at a position near the center position. A case where a portion of the support pieces overlaps one of adjoining two of the cutting blade pieces in a circumferential direction, and the other portion of the support pieces is disposed at a center position between adjoining two of the cutting blade pieces or disposed at a position near the center position. A case where the support pieces extend across adjoining two of the cutting blade pieces. In this case, both ends of each of the support pieces may overlap both of adjoining two of the cutting blade pieces in the circumferential direction.

In the present invention, it is preferable that the support pieces extend so as to overlap the cutting blade pieces adjacent to a reverse rotation side of the tip saw in the circumferential direction. According to this invention, due to the fact that the support pieces extend so as to overlap the cutting blade pieces adjacent to the reverse rotation side of the tip saw in the circumferential direction, the support pieces and the cutting blade pieces adjacent to the reverse rotation side of the tip saw are disposed adjacent to each other when the tip saw is viewed from the outer circumference, so that a portion thicker than the base metal of the tip saw can be continued from the support pieces to the cutting blade pieces adjacent to the reverse rotation side of the tip saw without a gap.

In the present invention, it is preferable that the support pieces are attached to an outer side of the base metal. According to this invention, due to the attachment of the support pieces to an outer side of the base metal, the tip saw can be easily manufactured at low cost without a decrease in strength of the base metal as compared with a case where the support pieces are provided on an inner side of the base metal.

Here, the outer side of the base metal is an outer side of an outer circumferential edge of the base metal. Tooth portions and concave portions provided at an outer circumferential portion of the tip saw are portions of the base metal. Therefore, the outer side of the base metal includes outer sides of the tooth portions and outer sides of the concave portions.

In the present invention, it is preferable that the support pieces are placed on an inner side of the base metal. According to this invention, due to provision of the support pieces on an inner side of the base metal, the concave portions of the tip saw are not narrowed as compared with a case where the support pieces are attached to an outer side of the base metal, so that chip discharge performance of the tip saw can be prevented from deteriorating.

Here, the inner side of the base metal is a radially inner side of the outer circumferential edge of the base metal. Tooth portions and concave portions provided on an outer circumferential portion of the tip saw are portions of the base metal. Therefore, the inner side of the base metal includes inner sides of the tooth portions and inner sides of the concave portions.

In the present invention, it is preferable that the cutting blade pieces and the support pieces are made of reciprocally different materials. According to this invention, since the cutting blade pieces and the support pieces are made of materials different from each other, by reducing the material cost of the support pieces to be lower than the material cost of the cutting blade pieces, the manufacturing cost of the tip saw can be reduced.

The tip saw of the present invention is a disc-shaped tip saw including cutting blade pieces on blade edges, and each of the cutting blade pieces extends to a reverse rotation side of the tip saw and includes a cutting edge portion having a cutting edge on a rotation side of the tip saw, and includes a support portion on a reverse rotation side of the tip saw, and the cutting blade pieces are configured to be thicker than the base metal of the tip saw from the cutting edge portion to the support portion.

According to this invention, the tip saw is a disc-shaped tip saw including cutting blade pieces on blade edges, and the cutting blade pieces extend to a reverse rotation side of the tip saw and each of the cutting blade pieces includes a cutting edge portion having a cutting edge on a rotation side of the tip saw, and includes a support portion on a reverse rotation side of the tip saw, and the cutting blade pieces are configured to be thicker than the base metal of the tip saw from the cutting edge portion to the support portion. Accordingly, the cutting edge portion and the support portion of each of the cutting blade pieces are successively inserted without gaps into a cut groove formed in the work material by the cutting blade pieces when cutting a work material with the tip saw, so that a width of the cut groove of the work material can be held larger than a thickness of the base metal of the tip saw for a long time as compared with the case where the support pieces are disposed between adjoining two of the cutting blade pieces.

In the present invention, it is preferable that the support portion of each of the cutting blade pieces extends to at least a center position between one of the cutting edges of adjoining two of the cutting blade pieces and the other of the cutting edges of adjoining two of the cutting blade pieces. According to this invention, due to extension of the support portion of each of the cutting blade pieces to a center position between one of the cutting edges of adjoining two of the cutting blade pieces and the other of the cutting edges of adjoining two of the cutting blade pieces, a width of a cut groove of a work material can be held for a long time as compared with the case where the support portions of the cutting blade pieces does not reach the center position.

In the present invention, it is preferable that adjoining two of the cutting blade pieces partially overlap in a circumferential direction. According to this invention, adjoining two of the cutting blade pieces are disposed adjacent to each other when the tip saw is viewed from the outer circumference, and cutting blade pieces circumferentially surround the base metal of the tip saw without gaps due to the fact that adjoining two of the cutting blade pieces partially overlap in the circumferential direction. Therefore, the cutting blade pieces can be continuously inserted without gaps into a cut groove formed in the work material by the cutting blade pieces when cutting a work material, and a width of the cut groove can constantly be maintained.

In the present invention, it is preferable that the cutting edge portion and the support portion of each of the cutting blade pieces are made of reciprocally different materials. According to this invention, the material cost of the support portion can reduce than the material cost of the cutting edge portion and the manufacturing cost of the tip saw can be reduced since the cutting edge portion and the support portion of each of the cutting blade pieces are made of reciprocally different materials.

### Effect of Invention

As described above, according to the present invention, since a disc-shaped tip saw having cutting blade pieces on blade edge portions is configured so that a support piece is disposed between two adjacent cutting blade pieces, or the cutting blade piece has a support portion extending to a reverse rotation side of the tip saw, when cutting a work material with the tip saw, by inserting the support piece or the support portion into a cut groove formed in the work material by the cutting blade piece, an excellent effect to hold a width of the cut groove in the work material can be obtained.

### BRIEF DESCRIPTION OF DRAWINGS

FIG. 1 is a plan view illustrating a tip saw of a first embodiment according to the present invention.

FIG. 2 is an enlarged view illustrating a range enclosed by an alternate long and short dash line i in FIG. 1.

FIG. 3 is a schematic end view illustrating a state viewed from an arrow L1 in FIG. 2.

FIG. 4 is a schematic plan view illustrating a state where a hollow work material is cut with the tip saw of the first embodiment.

FIG. 5 is an enlarged view illustrating a range enclosed by an alternate long and short dash line ii in FIG. 4.

FIG. 6 is a plan view illustrating a tip saw of a second embodiment.

FIG. 7 is an enlarged view illustrating a range enclosed by an alternate long and short dash line iii in FIG. 6.

FIG. 8 is a schematic end view illustrating a state viewed from an arrow L2 in FIG. 7.

FIG. 9 is a schematic plan view illustrating a state where a hollow work material is cut with the tip saw of the second embodiment.

FIG. 10 is an enlarged view illustrating a range enclosed by an alternate long and short dash line iv in FIG. 9.

FIG. 11 is a plan view illustrating a tip saw of a third embodiment.

FIG. 12 is an enlarged view illustrating a range enclosed by an alternate long and short dash line v in FIG. 11.

FIG. 13 is a schematic end view illustrating a state viewed from an arrow L3 in FIG. 12.

FIG. 14 is a schematic plan view illustrating a state where a hollow work material is cut with the tip saw of the third embodiment.

FIG. 15 is an enlarged view illustrating a range enclosed by an alternate long and short dash line vi in FIG. 14.

FIG. 16 is an enlarged view illustrating an outer circumferential portion of another tip saw related to the first embodiment.

FIG. 17 is an enlarged view illustrating an outer circumferential portion of an alternative tip saw related to the first embodiment.

FIG. 18 is an enlarged view illustrating an outer circumferential portion of another tip saw related to the second embodiment.

FIG. 19 is an enlarged view illustrating an outer circumferential portion of still another tip saw related to the second embodiment.

FIG. 20 is an enlarged view illustrating an outer circumferential portion of an alternative tip saw related to the second embodiment.

FIG. 21 is an enlarged view illustrating an outer circumferential portion of a further alternative tip saw related to the second embodiment.

FIG. 22 is an enlarged view illustrating an outer circumferential portion of another tip saw related to the third embodiment.

FIG. 23 is an enlarged view illustrating an outer circumferential portion of still another tip saw related to the third embodiment.

FIG. 24 is an enlarged view illustrating an outer circumferential portion of an alternative tip saw related to the third embodiment.

FIG. 25 is an enlarged view illustrating an outer circumferential portion of a further alternative tip saw related to the third embodiment.

FIG. 26 is an enlarged view illustrating an outer circumferential portion of a different tip saw related to the third embodiment.

FIG. 27 is an enlarged view illustrating an outer circumferential portion of another different tip saw related to the third embodiment.

FIG. 28 is an enlarged view illustrating an outer circumferential portion of a variant tip saw related to the third embodiment.

FIG. 29 is a plan view illustrating a state where a hollow work material is cut with a conventional tip saw.

FIG. 30 is an enlarged view illustrating a range enclosed by an alternate long and short dash line vii in FIG. 29.

FIG. 31 is a plan view illustrating a tip saw described in Patent Document 1.

FIG. 32 is a plan view illustrating a tip saw described in Patent Document 2.

### DESCRIPTION OF EMBODIMENTS

### First Embodiment

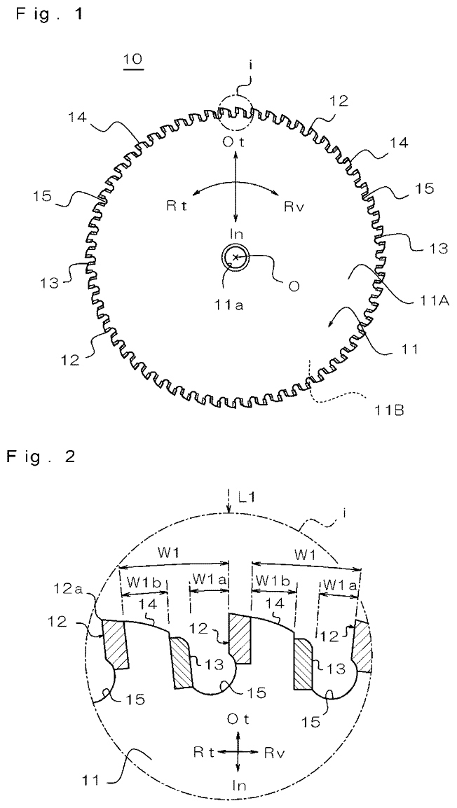

Hereinafter, a tip saw of a first embodiment according to the present invention will be described in detail. FIG. 1 is a plan view of the tip saw of the first embodiment according to the present invention. As illustrated in FIG. 1, a tip saw 10 is a disc-shaped circular saw, and includes a base metal 11, cutting blade pieces 12, and support pieces 13.

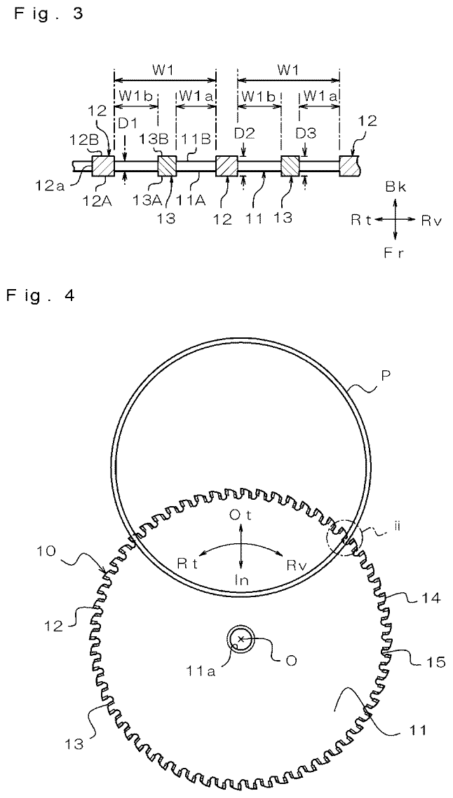

In the drawing, a direction indicated by an arrow Rt is a rotation side of the tip saw (a counterclockwise rotation side around a rotation center O in FIGS. 1, 4, 6, 9, 11, and 14, the left side on the sheet in FIGS. 2, 3, 7, 12, 13, and 16 to 28, and the upper left side on the sheet in FIGS. 5, 10, and 15). A direction indicated by an arrow Rv is a reverse rotation side of the tip saw (a clockwise rotation side around the rotation center O in FIGS. 1, 4, 6, 9, 11, and 14, the right side on the sheet in FIGS. 2, 3, 7, 12, 13, and 16 to 28, and the lower right side on the sheet in FIGS. 5, 10, and 15). A direction indicated by an arrow Ot is a radially outer side of the tip saw (a side separating from the rotation center O in FIGS. 1, 4, 6, 9, 11, and 14, the upper side on the sheet in FIGS. 2, 7, 12, and 16 to 28, the surface side of the sheet in FIGS. 3, 8, and 13, and the upper right side on the sheet in FIGS. 5, 10, and 15). A direction indicated by an arrow In is a radially inner side of the tip saw (a side approaching the rotation center O in FIGS. 1, 4, 6, 9, 11, and 14, the lower side on the sheet in FIGS. 2, 7, 12, and 16 to 28, the back side of the sheet in FIGS. 3, 8, and 13, and the lower left side on the sheet in FIGS. 5, 10, and 15). A direction indicated by an arrow Fr is a front surface side of the tip saw (the surface side of the sheet in FIGS. 1, 2, 4 to 7, 9 to 12, and 14 to 28, and the lower side on the sheet in FIGS. 3, 8, and 13). A direction indicated by an arrow Bk is a back surface side of the tip saw (the back side of the sheet in FIGS. 1, 2, 4 to 7, 9 to 12, and 14 to 28, and the upper side on the sheet of FIGS. 3, 8, and 13). A direction indicated by the arrow Rt and the arrow Rv is a circumferential direction of the tip saw. A direction indicated by the arrow Ot and the arrow In is a radial direction of the tip saw. A direction indicated by the arrow Fr and the arrow Bk is a thickness direction of the tip saw. These directions are for showing relative positional relationships, and are not for showing absolute positional relationships in the direction of gravitational force.

The base metal 11 is disc-shaped, and on its outer circumferential portion, tooth portions 14 and concave portions 15 are formed integrally. The tooth portion 14 is substantially rectangular, and projects to the radially outer side of the tip saw 10 indicated by the arrow Ot. The concave portion 15 has a concaved shape, and is concaved to the radially inner side of the tip saw 10 indicated by the arrow In. An inner bottom of the concave portion 15 is curved in an arc. These tooth portions 14 and concave portions 15 are alternately arranged one by one in the circumferential direction of the tip saw 10 indicated by the arrow Rt and the arrow Rv. In other words, the tooth portions 14 and the concave portions 15 are alternately arranged one by one around the rotation center O. In the illustrated example, the tooth portions 14 and the concave portions 15 are portions of the base metal 11. The tooth portions 14 and the concave portions 15 are each 60 in number. The tooth portions 14 are arranged at intervals of an angle of 6° around the rotation center O.

At a center of the base metal 11, an attaching hole 11a is formed. This attaching hole 11a is an opening for joining to an apparatus not illustrated which rotates the tip saw 10, and is pierced through front and back plate surfaces of the base metal 11. That is, the attaching hole 11a of the base metal 11 is pierced from a front surface 11A to a back surface 11B. A shape of the attaching hole 11a is not particularly limited, and in the illustrated example, is circular as viewed from the front surface 11A. At a center position of the attaching hole 11a, the rotation center O of the tip saw 10 is provided. In other words, the tip saw 10 is configured to be rotatable around the rotation center O.

FIG. 2 is an enlarged view illustrating a range enclosed by an alternate long and short dash line i in FIG. 1. As illustrated in FIG. 2, the cutting blade pieces 12 are substantially rectangular small pieces (tips), and are made of a material of a cutting tool. This material is, for example, cemented carbide, diamond sintered body (polycrystalline diamond, PCD), CBN sintered body (cubic boron nitride), cermet (compound material of ceramics and metal), Cermetal (registered trademark) (material intermediate between ceramics and cemented carbide), etc. At a corner portion of the cutting blade piece 12 where a rotation side indicated by the arrow Rt and a radially outer side of the tip saw cross each other, a cutting edge 12a is formed. The cutting edge 12a extends in a thickness direction from a front surface 12A of the cutting blade piece 12 to a back surface 12B (refer to FIG. 3). The cutting blade piece 12 is configured to cut a work material by the cutting edge 12a.

Next, as with the cutting blade piece 12, the support piece 13 is a substantially rectangular small piece (tip), and is made of a wear-resistant material, for example, cemented carbide, etc. The support piece 13 may be made of the same material as the cutting blade piece 12, or may be made of a material different from the material of the cutting blade piece 12. When the support piece 13 is made of a material different from the material of the cutting blade piece 12, by reducing the material cost of the support pieces 13 to be lower than the material cost of the cutting blade pieces 12, the manufacturing cost of the tip saw 10 can be reduced.

Here, typical cemented carbide is obtained by mixing tungsten carbide (WC) and cobalt (Co) as a binder and sintering them, and titanium carbide (TiC) and tantalum carbide (TaC) may be added as necessary.

The cutting blade piece 12 is attached to a rotation side of the tip saw 10 indicated by the arrow Rt in the tooth portion 14, and the support piece 13 is attached to a reverse rotation side of the tip saw 10 indicated by the arrow Rv in the tooth portion 14. Therefore, the cutting blade piece 12 and the support piece 13 are disposed to sandwich the tooth portion 14 from both the rotation side and reverse rotation side of the tip saw 10. Accordingly, the cutting blade pieces 12 and the support pieces 13 are alternately arranged one by one at intervals of a predetermined angle around the rotation center O of the tip saw 10. In the illustrated example, the cutting blade pieces 12 and the support pieces 13 are each 60 in number as with the tooth portions 14. A method of attaching these cutting blade pieces 12 and support pieces 13 is not particularly limited, and is, for example, brazing, soldering, welding, etc.

FIG. 3 is a schematic end view illustrating a state viewed from the arrow L1 in FIG. 2. As illustrated in FIG. 3, the cutting blade piece 12 is configured to be thicker than the base metal 11. A thickness direction of the cutting blade piece 12 is the thickness direction of the tip saw 10 indicated by the arrow Fr and the arrow Bk. The front surface 12A of the cutting blade piece 12 protrudes to the front surface side of the tip saw 10 indicated by the arrow Fr beyond a position of the front surface 11A of the base metal 11, and the back surface 12B of the cutting blade piece 12 protrudes to the back surface side of the tip saw 10 indicated by the arrow Bk beyond a position of the back surface 11B of the base metal 11. When the thickness of the cutting blade piece 12 is defined as D2, and the thickness of the base metal 11 is defined as D1, the thickness D2 of the cutting blade piece 12 is larger than the thickness D1 of the base metal 11 (D2>D1). The thickness D2 of the cutting blade piece 12 is a distance from the front surface 12A to the back surface 12B in the thickness direction, and the thickness D1 of the base metal 11 is a distance from the front surface 11A to the back surface 11B in the thickness direction. Accordingly, the cutting blade piece 12 is configured to cut a work material more widely than the thickness D1 of the base metal 11. Both of the tooth portions 14 and the concave portions 15 are portions of the base metal 11, and have a thickness equal to or nearly equal to the thickness D1 of the base metal 11.

Similarly, the support piece 13 is configured to be thicker than the base metal 11. A front surface 13A of the support piece 13 protrudes to the surface side of the tip saw beyond the position of the front surface 11A of the base metal 11, and a back surface 13B of the support piece 13 protrudes to the back surface side of the tip saw beyond the position of the back surface 11B of the base metal 11. When the thickness of the support piece 13 is defined as D3, and the thickness of the base metal 11 is defined as D1, the thickness D3 of the support piece 13 is larger than the thickness of the base metal 11 (D3>D1). The thickness D3 of the support piece 13 is a distance from the front surface 13A to the back surface 13B in the thickness direction.

The support piece 13 has a thickness equal to or nearly equal to the thickness of the cutting blade piece 12. The front surface 13A of the support piece 13 is disposed at the same position or at nearly the same position as the front surface 12A of the cutting blade piece 12 in the thickness direction, and the back surface 13B of the support piece 13 is disposed at the same position or at nearly the same position as the back surface 12B of the cutting blade piece 12 in the thickness direction. That is, the thickness D3 of the support piece 13 is equal to or nearly equal to the thickness D2 of the cutting blade piece 12 (D3=D2 or D3˜D2).

As illustrated in FIGS. 2 and 3, the support piece 13 is disposed between two cutting blade pieces 12 and 12 adjacent to each other in the circumferential direction. In a portion between the cutting blade piece 12 and the support piece 13 adjacent to the rotation side of the tip saw 10, and in a portion between the cutting blade piece 12 and the support piece 13 adjacent to the reverse rotation side, the base metal 11 is exposed from the outer circumference of the tip saw 10, respectively. Therefore, when viewing the tip saw 10 from the outer circumference, a portion between the cutting blade piece 12 and the support piece 13 adjacent to the rotation side of the tip saw 10, and a portion between the cutting blade piece 12 and the support piece 13 adjacent to the reverse rotation side of the tip saw 10, the thickness of the tip saw 10 in the thickness direction is smaller than the thickness of the cutting blade piece 12 and the support piece 13. In other words, an extending distance of a portion having the thickness D1 of the base metal 11 in the circumferential direction from the cutting blade piece 12 to the rotation side of the tip saw 10 is from the cutting blade piece 12 to the support piece 13 adjacent to the rotation side of the tip saw 10, and an extending distance of a portion having the thickness D1 of the base metal 11 in the circumferential direction from the cutting blade piece 12 to the reverse rotation side of the tip saw 10 is from the cutting blade piece 12 to the support piece 13 adjacent to the reverse rotation side of the tip saw 10.

Here, when the distance from the cutting blade piece 12 to the support piece 13 adjacent to the rotation side of the tip saw 10 is defined as W1a, the distance from the cutting blade piece 12 to the support piece 13 adjacent to the reverse rotation side of the tip saw 10 is defined as W1b, and the distance between two cutting blade pieces 12 and 12 adjacent to each other is defined as W1, the distance W1a and the distance W1b are respectively shorter than the distance W1, and a sum of the distance W1a and the distance W1b is shorter by a length of the support piece 13 in the circumferential direction of the tip saw 10 than the distance W1 (W1a<W1, W1b<W1, W1a+W1b<W1). In this case, the distance W1a is an extending distance of a portion having the thickness D1 of the base metal 11 from the cutting blade piece 12 to the rotation side of the tip saw 10 in the circumferential direction, and the distance W1b is an extending distance of a portion having the thickness D1 of the base metal 11 from the cutting blade piece 12 to the reverse rotation side of the tip saw 10 in the circumferential direction.

The support pieces 13 are respectively disposed so as to include at least a center position between two cutting blade pieces 12 and 12 adjacent to each other or a position near the center position. This includes a case where the support piece 13 is positioned at a center of two cutting blade pieces 12 and 12 adjacent to each other, and a case where a portion of the support piece 13 is positioned at a center of two cutting blade pieces 12 and 12 adjacent to each other while the support piece 13 is entirely biased toward one of the two cutting blade pieces 12 and 12 adjacent to each other. In this case, the distance W1a and the distance W1b are smaller than a half of the distance W1 (W1a<½*W1, W1b<½*W1), and variation between the distance W1a and the distance W1b is reduced. In other words, when viewing the tip saw 10 from the outer circumference, a portion where the base metal 11 is exposed becomes smaller in the circumferential direction of the tip saw 10.

FIG. 4 is a schematic plan view illustrating a state where a hollow work material is cut with the tip saw of the first embodiment. FIG. 5 is an enlarged view illustrating a range enclosed by an alternate long and short dash line ii in FIG. 3. As illustrated in FIGS. 4 and 5, when cutting the hollow work material P with the tip saw 10, the cutting blade piece 12 cuts into the work material P to form the cut groove Pc, and when the cutting blade piece 12 is inserted into the cut groove Pc, a width of the cut groove Pc is held equal to the thickness D2 of the cutting blade piece 12, and when the support piece 13 is inserted into the cut groove Pc, the width of the cut groove Pc is held equal to the thickness D3 of the support piece 13. When only a portion of the base metal 11 is inserted into the cut groove Pc of the work material P, the width of the cut groove Pc is held equal to the thickness D1 of the base metal 11. At this time, the thickness D3 of the support piece 13 is larger than the thickness D1 of the base metal 11 (D3>D1), and is equal to or nearly equal to the thickness D2 of the cutting blade piece 12 (D3=D2 or D3˜D2). Accordingly, when the support piece 13 is inserted into the cut groove Pc of the work material P, the width of the cut groove Pc is held larger than the thickness D1 of the base metal 11 and equal to or nearly equal to the thickness D2 of the cutting blade piece 12.

When the tip saw 10 configured as described above is rotated around the rotation center O to the rotation side of the tip saw 10 and cuts into the hollow work material P, while the cutting edges 12a of the cutting blade pieces 12 cut the work material P and form the cut groove Pc, the cutting blade piece 12, a portion of the base metal 11, the support piece 13, and a portion of the base metal 11 are successively inserted into the cut groove Pc to cut the work material P.

In the first embodiment, the support piece 13 is disposed between two cutting blade pieces 12 and 12 adjacent to each other, and the thickness D3 of the support piece 13 is larger than the thickness of the base metal 11 and equal to or nearly equal to the thickness D2 of the cutting blade piece 12. Therefore, when the tip saw 10 is rotated and cuts into the hollow work material P, the cutting edge 12a of the cutting blade piece 12 forms the cut groove Pc in the work material P. Thereafter, the cutting blade pieces 12 and the support pieces 13 are alternately continuously inserted one by one into the cut groove Pc to cut the work material P while a width of the cut groove Pc is held equal to or nearly equal to the thickness D2 of the cutting blade pieces 12. Accordingly, the tip saw can form a clean cut surface of the hollow work material P as compared with a tip saw which does not have the support pieces 13.

In the first embodiment, an extending distance of a portion having the thickness D1 of the base metal 11 from the cutting blade piece 12 to the rotation side of the tip saw 10 in the circumferential direction is the distance W1a between the cutting blade piece 12 and the support piece 13 adjacent to the rotation side of the tip saw 10, an extending distance of a portion having the thickness D1 of the base metal 11 from the cutting blade piece 12 to the reverse rotation side of the tip saw 10 in the circumferential direction is the distance W1b between the cutting blade piece 12 and the support piece 13 adjacent to the reverse rotation side of the tip saw 10, and these distances W1a and W1b are shorter than the distance W1 between two cutting blade pieces 12 and 12 adjacent to each other (W1a<W1, W1b<W1), and in this configuration, extending distances of portions having the thickness D1 of the base metal 11 from the cutting blade piece 12 to the rotation side and the reverse rotation side of the tip saw 10 in the circumferential direction are shorter than in a case where the support pieces 13 are not provided, that is, a case where extending distances of portions having the thickness D1 of the base metal 11 from the cutting blade piece 12 to the rotation side and the reverse rotation side of the tip saw 10 in the circumferential direction are respectively the distance W1. Therefore, when cutting the work material P with the tip saw 10, a width of the cut groove Pc of the work material P can be held wide by the support pieces 13.

In addition, since the support piece 13 is disposed to include at least a center position between two cutting blade pieces 12 and 12 adjacent to each other or a position near the center position, both of the distance W1a from the cutting blade piece 12 to the support piece 13 adjacent to the rotation side of the tip saw 10 and the distance W1b from the cutting blade piece 12 to the support piece 13 adjacent to the reverse rotation side of the tip saw 10 are smaller than a half of the distance W1 between two cutting blade pieces 12 and 12 adjacent to each other (W1a<½*W1, W1b<½*W1), and accordingly, when cutting the work material P with the tip saw 10, variation in timings at which the cutting blade pieces 12 and the support pieces 13 are alternately inserted one by one into the cut groove Pc of the work material P can be reduced.

### Second Embodiment

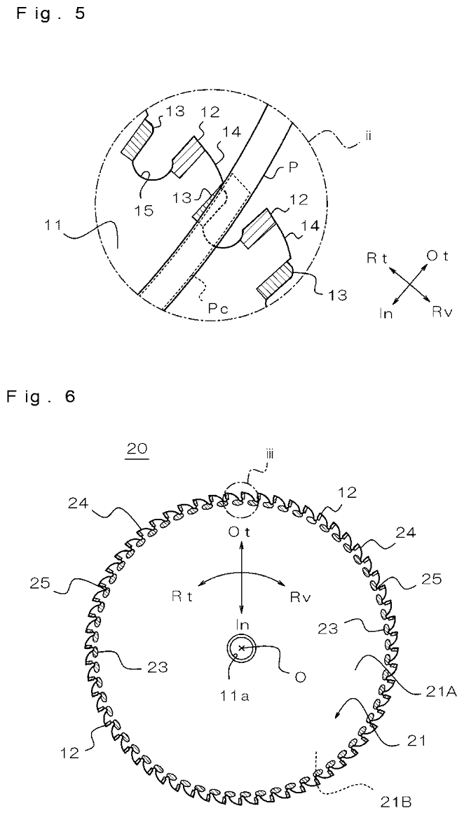

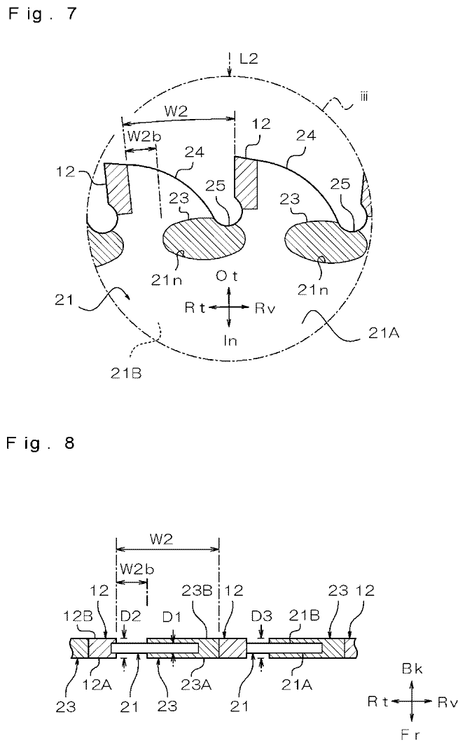

FIG. 6 is a plan view illustrating a tip saw of a second embodiment. FIG. 7 is an enlarged view illustrating a range enclosed by an alternate long and short dash line iii in FIG. 6. As illustrated in FIGS. 6 and 7, while the support pieces 13 of the tip saw 10 of the first embodiment are attached to an outer side of the base metal 11, support pieces 23 of a tip saw 20 of the second embodiment are provided on an inner side of a base metal 21. The inner side of the base metal 21 means a radially inner side of an outer circumferential edge of the base metal 21. Tooth portions 24 and concave portions 25 are portions of the base metal 21, so that the inner side of the base metal 21 includes radially inner sides of the outer peripheral edges of the tooth portions 24 and radially inner sides of outer peripheral edges of the concave portions 25. The same portions as in the tip saw 10 of the first embodiment are provided with the same reference signs, and descriptions thereof will be omitted. Cutting blade pieces 12 of the second embodiment are the same as the cutting blade pieces 12 of the first embodiment. The support pieces 23 of the second embodiment are made of the same material as the support pieces 13 of the first embodiment.

As illustrated in FIG. 7, the inner side of the base metal 21 means a radially inner side of the outer circumferential edge of the base metal 21. Specifically, notches 21n are formed in the base metal 21. Each of the notches 21n is disposed at a radially inner side of a portion ranging from the tooth portion 24 to the concave portion 25. The notch 21n is oval or elliptic as viewed from a front surface 21A of the base metal 21, and penetrates from the front surface 21A to a back surface 21B of the base metal 21. The support piece 23 is fitted in the notch 21n, and has the same planar shape as the notch 21n. In other words, the support pieces 23 are oval or elliptic. Therefore, as compared with a case where the support pieces 23 are attached to outer sides of the tooth portions 24, the concave portions 25 of the tip saw 20 are not narrowed, and the chip discharge performance can be prevented from deteriorating. Although the notches 21n are formed at an outer rim portion of the base metal 21, openings or through holes may be provided instead at a radially inner side of the outer rim portion of the base metal 21.

FIG. 8 is a schematic end view illustrating a state viewed from the arrow L2 in FIG. 7. As illustrated in FIGS. 7 and 8, between two cutting blade pieces 12 and 12 adjacent to each other, the support piece 23 is disposed at a position biased toward the cutting blade piece 12 on the reverse rotation side of the tip saw 20, and a portion of the support piece 23 is positioned at a center of the two adjacent cutting blade pieces 12 and 12, and the other portion extends so as to overlap the cutting blade piece 12 on the reverse rotation side of the tip saw 20 in the circumferential direction. In this case, the base metal 21, the support pieces 23, and the cutting blade pieces 12 of the second embodiment respectively have thicknesses D1, D3, and D2 equal to the thicknesses of the base metal 11, the support pieces 13, and the cutting blade pieces 12 of the first embodiment. Therefore, when viewing the tip saw 20 from the outer circumference, the support piece 23 and the cutting blade piece 12 adjacent to the reverse rotation side are disposed adjacent to each other in the circumferential direction, and are continuous with each other with the same thickness or nearly the same thickness. In other words, a front surface 23A of the support piece 23 and the front surface 12A of the cutting blade piece 12 adjacent to the reverse rotation side are continuous with each other in the circumferential direction without a difference in level, and a back surface 23B of the support piece 23 and the back surface 12B of the cutting blade piece 12 adjacent to the reverse rotation side are continuous with each other in the circumferential direction without a difference in level.

In addition, as illustrated in FIG. 8, when viewing the tip saw 20 from the outer circumference, a portion having the thickness D1 of the base metal 21 extends from the cutting blade piece 12 to the reverse rotation side of the tip saw 20, but does not extend from the cutting blade piece 12 to the rotation side of the tip saw 20. A distance of the portion having the thickness D1 of the base metal 21 in the circumferential direction is a distance W2b from the cutting blade piece 12 to the support piece 23 adjacent to the reverse rotation side of the tip saw 20. In other words, of a distance W2 between two cutting blade pieces 12 and 12 adjacent to each other, a portion having the thickness D1 of the base metal 21 is only the distance W2b. Therefore, in the tip saw 20, the portion having the thickness D1 of the base metal 21 exposed from the outer circumference of the tip saw 20, can be made smaller than in the tip saw 10 of the first embodiment.

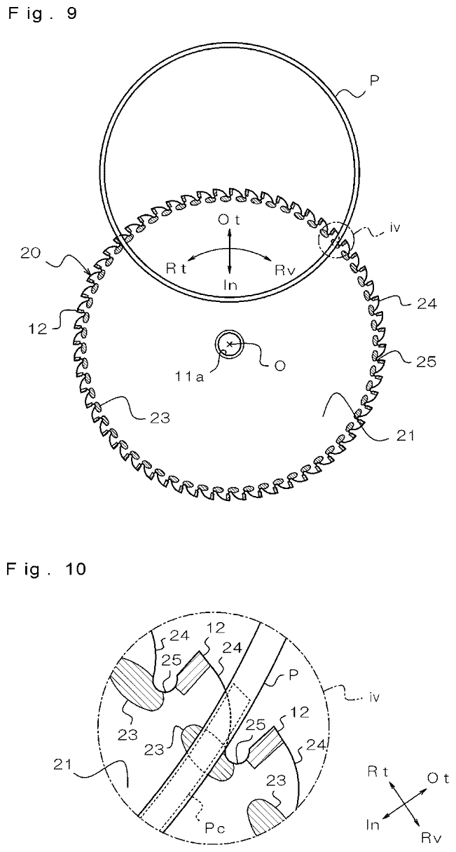

FIG. 9 is a schematic plan view illustrating a state where a hollow work material is cut with the tip saw of the second embodiment. FIG. 10 is an enlarged view illustrating a range enclosed by an alternate long and short dash line iv in FIG. 9. As illustrated in FIGS. 9 and 10, when cutting the hollow work material P with the tip saw 20, as the support piece 23 is inserted into the cut groove Pc formed in the work material P by the cutting edge 12a of the cutting blade piece 12, a width of the cut groove Pc is held equal to the thickness D3 of the support piece 23, that is, equal to or nearly equal to the thickness D2 of the cutting blade piece 12.

When the tip saw 20 configured as described above is rotated around the rotation center O to the rotation side of the tip saw and cuts into the hollow work material P, while the cutting edge 12a of the cutting blade piece 12 cuts the work material P to form the cut groove Pc, the cutting blade piece 12, a portion of the base metal 21, and the support piece 23 are successively inserted into the cut groove Pc to cut the work material P.

In the second embodiment, since the support pieces 23 are disposed on the inner side of the base metal 21, as compared with the tip saw 10 of the first embodiment in which the support pieces 13 are attached to outer sides of the tooth portions 14, the support pieces 23 do not narrow the concave portions 25 of the tip saw 20, so that the chip discharge performance of the tip saw 20 can be prevented from deteriorating.

In this second embodiment, the support piece 23 and the cutting blade piece 12 adjacent to the reverse rotation side of the tip saw 20 overlap in the circumferential direction, and when viewing the tip saw 20 from the outer circumference, the support piece 23 and the cutting blade piece 12 adjacent to the reverse rotation side of the tip saw 20 are disposed adjacent to each other, and accordingly, the support piece 23 and the cutting blade piece 12 adjacent to the reverse rotation side of the tip saw 20 are continuous with each other with the same thickness or nearly the same thickness, so that a width of the cut groove Pc of the work material P can be maintained widely for a longer time than in the case using the tip saw 10 of the first embodiment.

### Third Embodiment

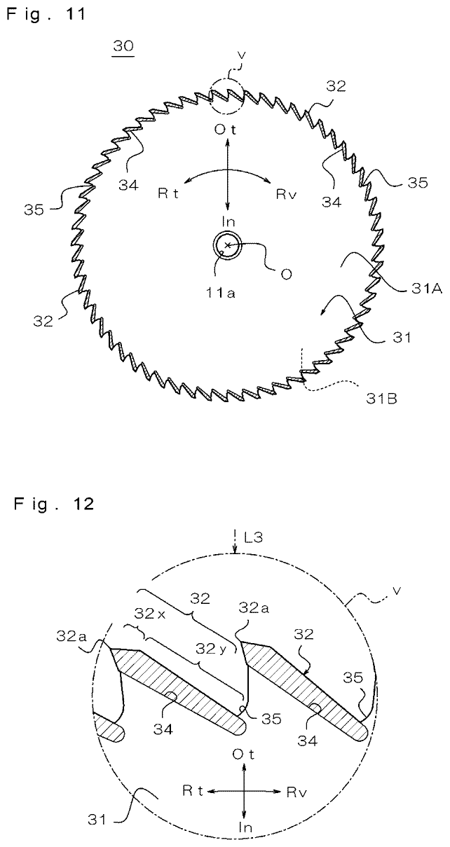

FIG. 11 is a plan view illustrating a tip saw of a third embodiment. FIG. 12 is an enlarged view illustrating a range enclosed by an alternate long and short dash line v in FIG. 11. As illustrated in FIGS. 11 and 12, although the support pieces 13, 23 are provided between two cutting blade pieces 12, 12 adjacent to each other in the tip saw 10 of the first embodiment and the tip saw 20 of the second embodiment, in a tip saw 30 of the third embodiment, no support pieces are provided, and cutting blade pieces 32 extend to the reverse rotation side of the tip saw 30. The same portions as in the tip saw 10 of the first embodiment are provided with the same reference signs, and descriptions thereof will be omitted. The cutting blade pieces 32 of the third embodiment are made of the same material as the cutting blade pieces 12 of the first embodiment.

The cutting blade piece 32 of the third embodiment has a long and narrow shape, and has a cutting edge 32a at an end portion on the rotation side of the tip saw 30. The cutting blade piece 32 is attached to a radially outer side of a tooth portion 34, and extends obliquely along an outer peripheral edge of the tooth portion 34 from the cutting edge 32a on the rotation side to the reverse rotation side of the tip saw 30. In the illustrated example, the cutting blade piece 32 covers the entire outer peripheral edge of the tooth portion 34. A method of attaching the cutting blade piece 32 to the tooth portion 34 is not particularly limited, and is, for example, brazing, soldering, welding, etc.

As illustrated in FIG. 12, the cutting blade piece 32 has a cutting edge portion 32x and a support portion 32y. The cutting edge portion 32x is a portion of the cutting blade piece 32 on the rotation side of the tip saw 30, and includes the cutting edge 32a. The support portion 32y is a portion of the cutting blade piece 32 on the reverse rotation side of the tip saw 30. The cutting edge portion 32x and the support portion 32y have the same thickness D2. Accordingly, after the cutting blade piece 32 forms the cut groove Pc in the work material P by the cutting edge 32a of the cutting edge portion 32x, a width of the cut groove Pc can be maintained equal to the thickness D2 of the cutting blade piece 32 by the support portion 32y.

FIG. 13 is an end view illustrating a state viewed from the arrow L3 in FIG. 12. As illustrated in FIGS. 12 and 13, the cutting blade piece 32 partially overlaps the cutting blade piece 32 adjacent to the reverse rotation side of the tip saw 30 in the circumferential direction. In other words, two cutting blade pieces 32 and 32 adjacent to each other partially overlap in the circumferential direction. Specifically, the support portion 32y of one of the two cutting blade pieces 32 and 32 adjacent to each other overlaps the cutting edge portion 32x of the other cutting blade piece 32 in the circumferential direction. In other words, the cutting blade pieces 32 are arranged at intervals of a predetermined angle around the rotation center O so as to partially overlap in the circumferential direction, and surround the base metal 31 without gaps in the circumferential direction.

As illustrated in FIG. 13, in this state, when viewing the tip saw 30 from the outer circumference, two cutting blade pieces 32 and 32 adjacent to each other are disposed adjacent to each other without gaps in the circumferential direction, and are continuous with each other while keeping the same thickness D2 from one cutting blade piece 32 to the other cutting blade piece 32. In other words, a front surface 32A of one of two cutting blade pieces 32 and 32 adjacent to each other and the front surface 32A of the other cutting blade piece 32 are continuous with each other in the circumferential direction without a difference in level, and a back surface 32B of one cutting blade piece 32 and the back surface 32B of the other cutting blade piece 32 are continuous with each other in the circumferential direction without a difference in level. Accordingly, the cutting blade pieces 32 can be continuously inserted into the cut groove P of the work material P with no interval.

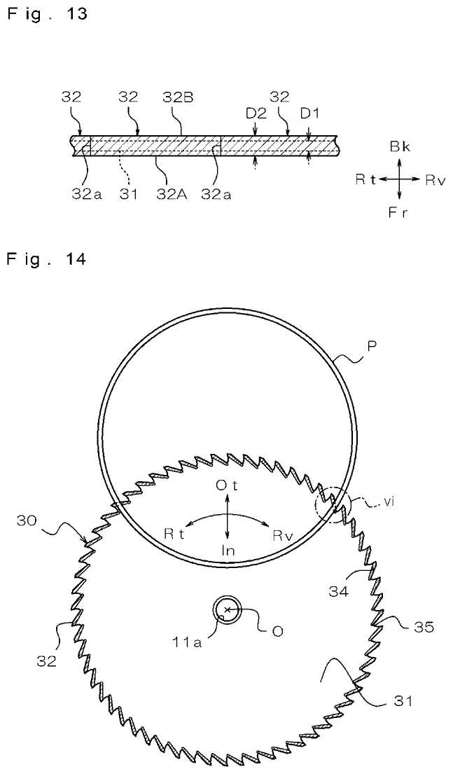

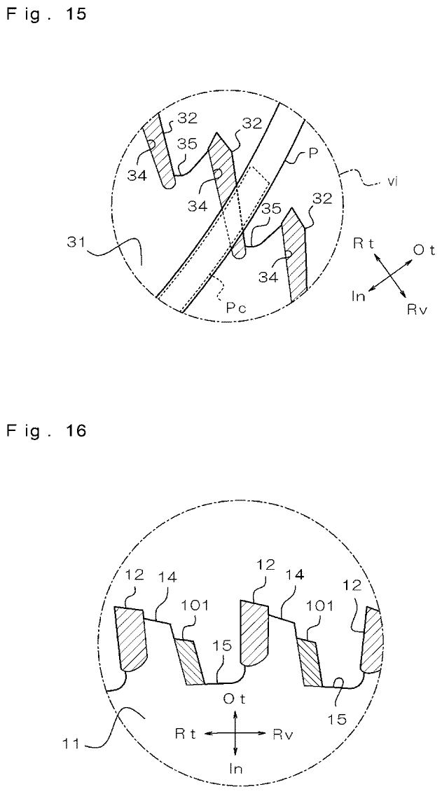

FIG. 14 is a schematic plan view illustrating a state where a hollow work material is cut with the tip saw of the third embodiment. FIG. 15 is an enlarged view illustrating a range enclosed by an alternate long and short dash line vi in FIG. 14. As illustrated in FIGS. 14 and 15, when cutting the work material P with the tip saw 30, as the cutting blade piece 32 is inserted into the cut groove Pc formed by the cutting edge 32a of the cutting blade piece 32, a width of the cut groove Pc is maintained equal to the thickness D2 of the cutting blade piece 32.

When the tip saw 30 configured as described above is rotated around the rotation center O to the rotation side and cuts into the hollow work material P, while the cutting edges 32a of the cutting blade pieces 32 cut the work material P to form the cut groove pc, the cutting blade pieces 32 are successively inserted into the cut groove Pc with no interval and cut the work material P.

In the third embodiment, since the tip saw 30 is not provided with the support pieces 13, 23, the number of components can be reduced and the manufacturing cost can be reduced as compared with the tip saws 10 and 20 of the first embodiment and the second embodiment each including both of the cutting blade pieces 12 and the support pieces 13, 23.

In this third embodiment, the cutting blade pieces 32 extend to the reverse rotation side of the tip saw 30, and two cutting blade pieces 32 and 32 adjacent to each other partially overlap in the circumferential direction so that the cutting blade pieces 32 circumferentially surround the base metal 31 without gaps, and accordingly, when cutting the hollow work material P with the tip saw 30, the cutting blade pieces 32 are successively inserted into the cut groove Pc formed in the work material P by the cutting edges 32a of the cutting blade pieces 32 with no interval, so that a width of the cut groove Pc can always be held equal to the thickness D2 of the cutting blade pieces 32, and a cleaner cut surface than in the case using the tip saws 10 and 20 of the first embodiment and the second embodiment can be obtained.

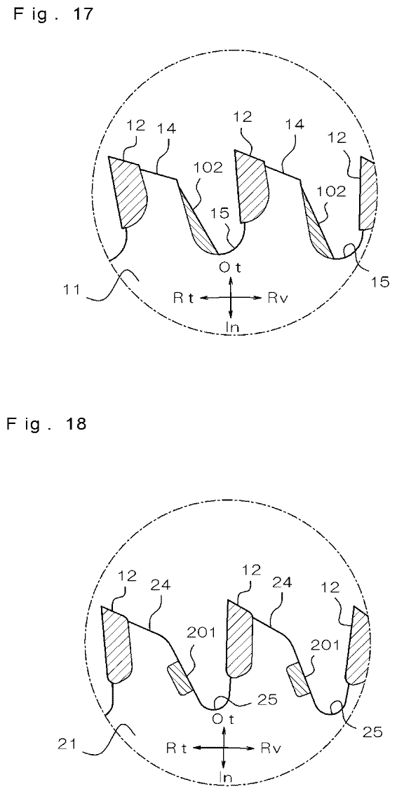

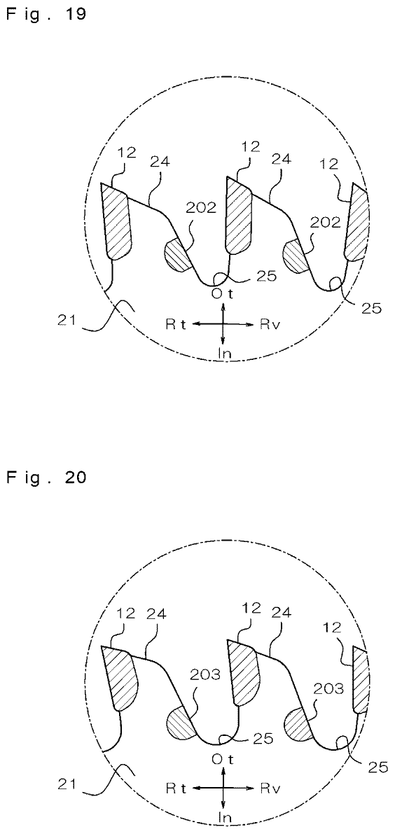

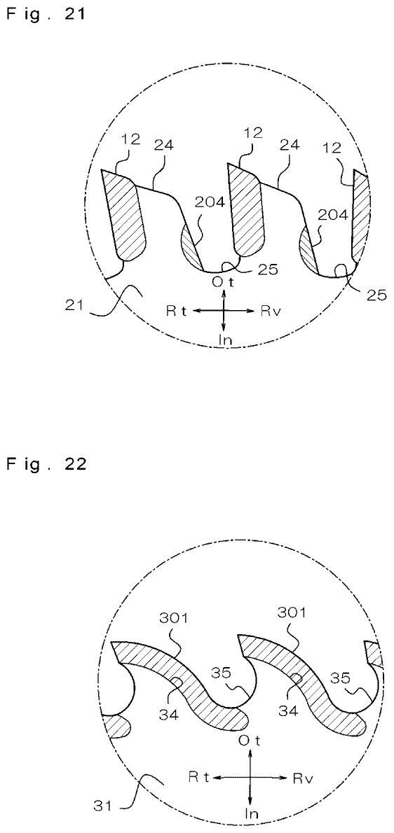

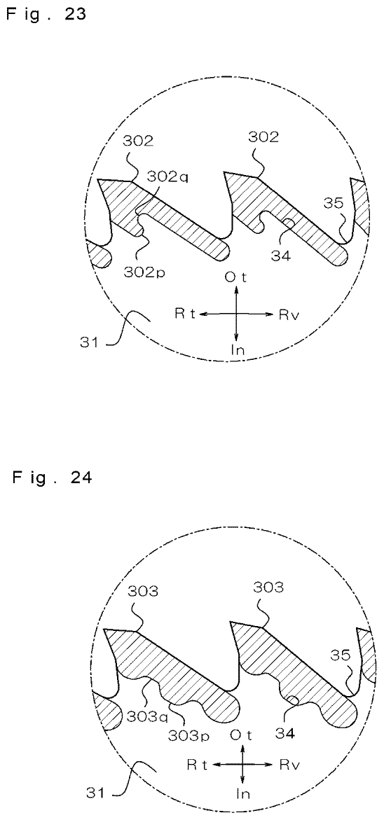

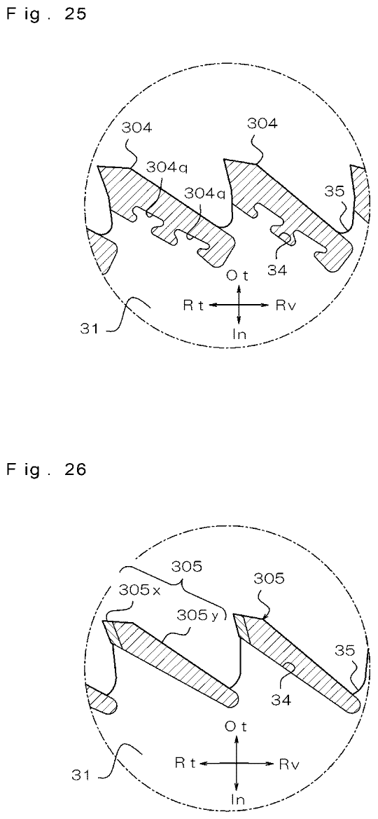

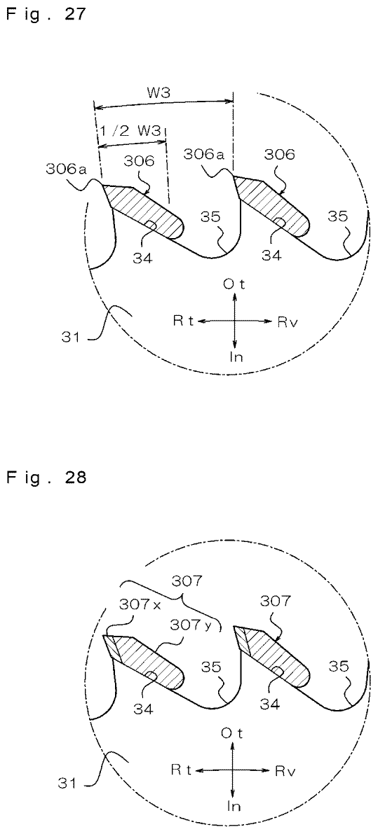

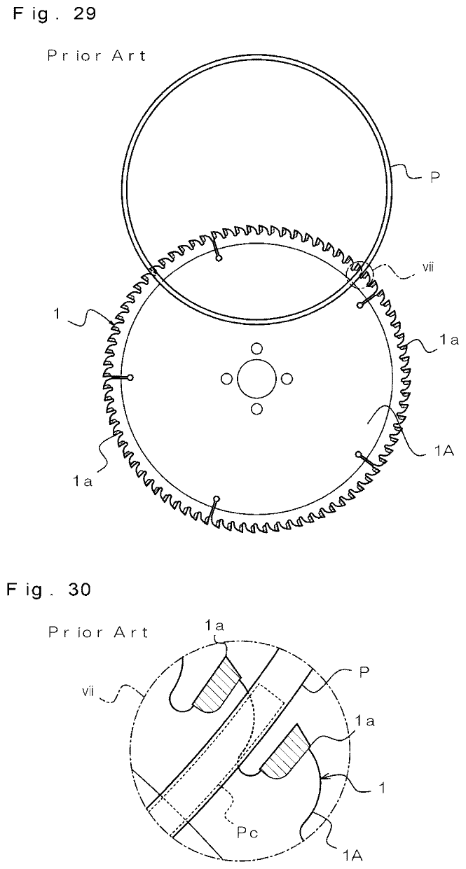

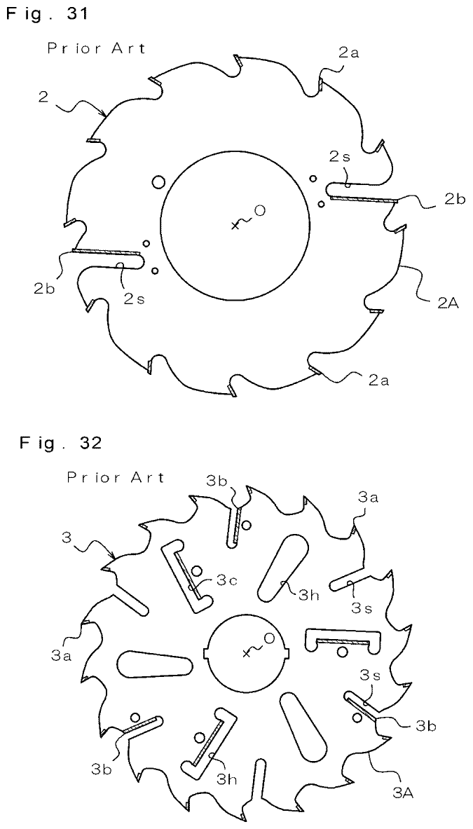

As a matter of course, the tip saws 10, 20, and 30 of the first to third embodiments are not limited to the illustrated examples described above, and can be variously modified without departing from the scope of the present invention. For example, whereas the support piece 13 of the first embodiment has a rectangular shape having a round corner (refer to FIG. 2), a support piece 101 may have a rectangular shape having pointed corners (refer to FIG. 16), and a support piece 102 may have a substantially triangular shape having an oblique side extending straight from an end portion (protruding end) at a radially outer side of the tooth portion 14 to an inner bottom of the concave portion 15 (refer to FIG. 17).

Whereas the support piece 23 in the second embodiment is disposed at a radially inner side of a portion ranging from the tooth portion 24 to the concave portion 25 (refer to FIG. 7), the support piece 23 may be disposed at a radially inner side of the tooth portion 24 (root portion of the tooth portion 24), or may be disposed at a radially inner side of the concave portion 25. Each support piece 201, 202, 203, 204 may be disposed at a portion of the tooth portion 24 on the reverse rotation side of the tip saw 20 (refer to FIGS. 18 to 21).

Whereas the support piece 23 in the second embodiment is oval or elliptic (refer to FIG. 7), a planar shape of the support piece 23 is not particularly limited, and may be, for example, circular or polygonal such as pentagonal, hexagonal, or octagonal. The support piece 201 may be rectangular (refer to FIG. 18), the support piece 202 may be semi-cylindrical (refer to FIG. 19), the support piece 203 may be semicircular (refer to FIG. 20), and the support piece 204 may be crescent-shaped (refer to FIG. 21).

Whereas the cutting blade piece 32 in the third embodiment extends straight obliquely from the rotation side to the reverse rotation side of the tip saw 30 (refer to FIG. 12), a cutting blade piece 301 may be curved (refer to FIG. 22).

Whereas a portion at a radially inner side of the cutting blade piece 32 in the third embodiment, that is, a portion in contact with the tooth portion 34 is flat (refer to FIG. 12), portions of cutting blade pieces 302, 303, and 304 in contact with the tooth portions 34 are preferably concavo-convex (refer to FIGS. 23 to 25). Accordingly, the cutting blade pieces 302, 303, and 304 hardly come off the tooth portions 34. Specifically, on the cutting blade piece 302, a protrusion 302p protruding in an extending direction of the cutting blade piece 302 and a recess 302q recessed in the extending direction are formed (refer to FIG. 23). On the cutting blade piece 303, a protrusion 303p protruding in a direction crossing an extending direction of the cutting blade piece 303, that is, in a direction in which the cutting blade piece is in contact with the tooth portion 34, and a recess 303q recessed in the contact direction, are formed (refer to FIG. 24). On the cutting blade piece 304, dovetail grooves 304q and 304q recessed in a direction in which the cutting blade piece is in contact with the tooth portion 34 are formed (refer to FIG. 25).

Whereas the cutting blade piece 32 in the third embodiment is entirely made of one material, the cutting blade piece 32 may be made of materials different between the cutting edge portion 32x on the rotation side of the tip saw 30 and the support portion 32y on the reverse rotation side of the tip saw 30. For example, as illustrated in FIG. 26, in a cutting blade piece 305, a cutting edge portion 305x is made of the same cutting tool material as the cutting blade piece 12 of the first embodiment, and a support portion 305y is made of the same wear-resistant material as the support piece 13 of the first embodiment. Accordingly, the manufacturing cost of the tip saw can be reduced.

Whereas two cutting blade pieces 32 and 32 adjacent to each other in the third embodiment are disposed so as to partially overlap in the circumferential direction, two cutting blade pieces 306 and 306, 307 and 307 adjacent to each other may be disposed not to overlap in the circumferential direction (refer to FIGS. 27 and 28). For example, as illustrated in FIG. 27, when a distance from a cutting edge 306a of one of two cutting blade pieces 306 and 306 adjacent to each other to a cutting edge 306a of the other cutting blade piece 306 is defined as W3, the cutting blade piece 306 may extend along an outer peripheral edge of the tooth portion 34 to at least a position corresponding to a half of the distance W3 (½*W3) in the circumferential direction. Accordingly, as compared with a conventional tip saw, a portion in which the base metal 31 is exposed from the outer circumference of the tip saw can be narrowed, and the manufacturing cost of the tip saw can be reduced.

In this case, as illustrated in FIG. 28, in the cutting blade piece 307, a cutting edge portion 307x on the rotation side of the tip saw 30 and a support portion 307y on the reverse rotation side of the tip saw 30 may be made of materials different from each other. That is, the cutting edge portion 307x of the cutting blade piece 307 is made of the same cutting tool material as the cutting blade piece 12 of the first embodiment, and the support portion 307y of the cutting blade piece 307 is made of the same wear-resistant material as the support piece 13 of the first embodiment. Accordingly, the manufacturing cost of the tip saw can be reduced.

### REFERENCE SIGNS LIST

1, 2, 3, 10, 20, 30: tip saw, 1a, 12, 32, 301, 302, 303, 304, 305, 306, 307: cutting blade piece, 1A, 3A, 11, 21, 31: base metal, 2a, 3a: first cutting blade piece, 2b, 3b: second cutting blade piece, 2s, 3s: groove, 3c: third cutting blade piece, 3h: slot, 11a: attaching hole, 11A, 12A, 13A, 21A, 23A, 32A: front surface, 11B, 12B, 13B, 21B, 23B, 32B: back surface, 12a, 32a, 306a: cutting edge, 13, 23, 101, 102, 201, 202, 203, 204: support piece, 14, 24, 34: tooth portion, 15, 25: concave portion, 21n: notch, 302p, 303p: protrusion, 302q, 303q: recess, 304q: dovetail groove, 32x, 305x, 307x: cutting edge portion, 32y, 305y, 307y: support portion, D1, D2, D3: thickness, O: rotation center, P: work material, Pc: cut groove, Rt, Rv, Ot, In, Fr, Bk, L1, L2, L2: arrow, W1, W1a, W1b, W2, W2b, W3: distance, i, ii, iii, iv, v, vi: alternate long and short dash line

What is claimed is:

1. A tip saw having a disc-shape and comprising cutting blade pieces and a base metal, wherein
the cutting blade pieces are disposed on blade edges of the tip saw, and each of the cutting blade pieces extends to a reverse rotation side of the each of the cutting blade pieces along an outer side of the tip saw,
two of the cutting blade pieces adjacent to each other partially overlap in a circumferential direction along the outer side of the tip saw,
the each of the cutting blade pieces has a cutting edge portion on a rotation side of the each of the cutting blade pieces and a support portion on the reverse rotation side of the each of the cutting blade pieces,
the cutting edge portion and the support portion have a same thickness and, the thickness of the cutting edge portion and the support portion is larger than a thickness of the base metal,
the cutting edge portion and the support portion of the each of the cutting blade pieces are made of different materials from each other, and
the support portion of the each of the cutting blade pieces is made of a wear resistant material.

2. The tip saw according to claim 1, wherein
the support portion of the each of the cutting blade pieces is made of a cemented carbide.

3. A tip saw having a disc-shape and comprising cutting blade pieces and a base metal, wherein
the cutting blade pieces are disposed on blade edges of the tip saw, and each of the cutting blade pieces extends to a reverse rotation side of the each of the cutting blade pieces along an outer side of the tip saw,
the cutting blade pieces comprise a first cutting blade piece and a second cutting blade piece,
the first cutting blade piece and the second cutting blade piece are adjacent to each other,
the each of the cutting blade pieces extends to at least a half of a distance between the first cutting blade piece and the second cutting blade piece,
the each of the cutting blade pieces has a cutting edge portion on a rotation side of the each of the cutting blade pieces and a support portion on the reverse rotation side of the each of the cutting blade pieces,
the cutting edge portion and the support portion have a same thickness and, the thickness of the cutting edge portion and the support portion is larger than a thickness of the base metal,
the cutting edge portion and the support portion of the each of the cutting blade pieces are made of different materials from each other, and
the support portion of the each of the cutting blade pieces is made of a wear resistant material.

4. The tip saw according to claim 3, wherein
the support portion of the each of the cutting blade pieces is made of a cemented carbide.
